(19) United States
(12) Patent Application Publication
(10) Pub. No.: US 2026/0018671 A1
(43) Pub. Date: Jan. 15, 2026

(54) SECONDARY BATTERY AND ELECTRONIC DEVICE

(71) Applicant: Ningde Amperex Technology Limited, Ningde (CN)

(72) Inventors: Yezhen ZHENG, Ningde (CN); Shaoyun ZHOU, Ningde (CN); Mengyan LIN, Ningde (CN); Disheng LAN, Ningde (CN)

(73) Assignee: Ningde Amperex Technology Limited, Ningde (CN)

(21) Appl. No.: 19/337,263

(22) Filed: Sep. 23, 2025

Related U.S. Application Data
(63) Continuation of application No. PCT/CN2023/083311, filed on Mar. 23, 2023.

(51) Int. Cl. H01M 10/0567; H01M 4/02; H01M 4/583

(52) U.S. Cl. CPC H01M 10/0567; H01M 4/583; H01M 2004/028

(57) ABSTRACT

A secondary battery includes a positive electrode plate, a negative electrode plate, and an electrolyte. The electrolyte includes vinylene carbonate, and based on a total mass of the electrolyte, a mass percentage a of the vinylene carbonate is 0.1% to 3%. The positive electrode plate includes a positive electrode active material, the positive electrode active material includes carbon element, and based on a total mass of the positive electrode active material, a mass percentage b of the carbon element is 0.5% to 6%.

### CROSS REFERENCE TO THE RELATED APPLICATIONS

This application is a continuation under 35 U.S.C. § 120 of international patent application PCT/CN2023/083311 filed on Mar. 23, 2023, the entire content of which is incorporated herein by reference.

### TECHNICAL FIELD

This application relates to the field of electrochemical technologies, and in particular, to a secondary battery and an electronic device.

### BACKGROUND

Currently, secondary batteries have been widely applied in fields such as electric vehicles, consumer electronic products, and energy storage devices, and have gradually become the mainstream batteries in these fields due to their advantages such as high energy density and no memory effect. In particular, the electric vehicle, power, and energy storage industries have entered a phase of rapid development, providing broad application prospects for secondary batteries.

Due to the inherent characteristics of lithium iron phosphate positive electrode materials, secondary batteries formed by lithium iron phosphate positive electrode materials exhibit high safety performance, long service life, good high-temperature performance, low cost, and environmental friendliness, possessing significant advantages and promising application prospects compared to other types of secondary batteries. Despite these advantages, as increasingly high requirements are imposed on secondary batteries in fields such as power and energy storage, how to further improve the cycling performance, storage performance, and kinetic performance of lithium-ion batteries still holds a significant value.

### SUMMARY

An objective of this application is to provide a secondary battery and an electronic device, where the secondary battery possesses excellent kinetic performance while exhibiting good cycling performance and storage performance. Specific technical solutions are as follows.

A first aspect of this application provides a secondary battery including a positive electrode plate, a negative electrode plate, and an electrolyte. The electrolyte includes vinylene carbonate, and based on a total mass of the electrolyte, a mass percentage a of the vinylene carbonate is 0.1% to 3%. The positive electrode plate includes a positive electrode active material, the positive electrode active material includes carbon element, and based on a total mass of the positive electrode active material, a mass percentage b of the carbon element is 0.5% to 6%. The electrolyte and the positive electrode plate in the secondary battery provided in this application satisfy the above characteristics, enabling simultaneous enhancement of ion conductivity and electron conductivity of the secondary battery, as well as reduction of a consumption rate of the electrolyte, thereby allowing the secondary battery to possess excellent kinetic performance while exhibiting good cycling performance and storage performance.

In some embodiments of this application, a is 0.1% to 2.5%, preferably 0.5% to 2.5%, more preferably 0.8% to 2.5%; and/or b is 0.5% to 5%, preferably 0.5% to 4.5%. By controlling values of a and b within the above ranges, the cycling performance, storage performance, and kinetic performance of the secondary battery can be further improved.

In some embodiments of this application, a ratio of a to b is in a range of 0.22 to 6. By controlling the ratio of a to b within the above range, a high-quality electrolyte interface film can be formed on a surface of a positive electrode, and deterioration of interface impedance can also be prevented, further improving the cycling performance, storage performance, and kinetic performance of the secondary battery.

In some embodiments of this application, the electrolyte further includes a nitrogen-containing heterocyclic compound, and based on the total mass of the electrolyte, a mass percentage c of the nitrogen-containing heterocyclic compound is 0.01% to 1%. By controlling the mass percentage c of the nitrogen-containing heterocyclic compound within the above range, the cycling performance of the secondary battery can be improved.

In some embodiments of this application, a ratio of a to c is in a range of 2 to 60. By controlling a ratio of a to c within the above range, the cycling performance and storage performance of the secondary battery can be further improved.

In some embodiments of this application, the nitrogen-containing heterocyclic compound includes the following compound represented by formula (I) or formula (II):

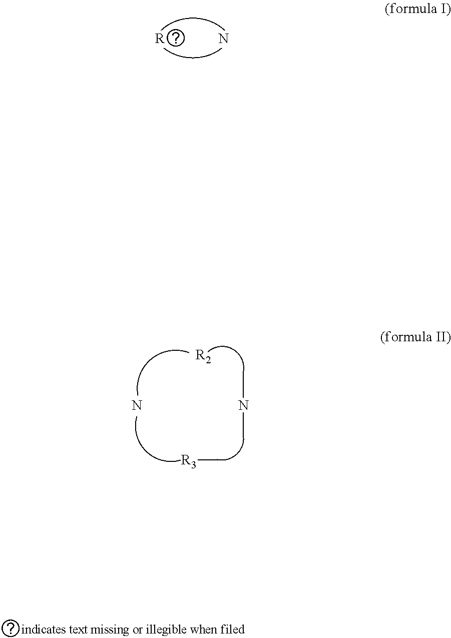

where R₁, R₂, and R₃ are each independently selected from any one of a substituted or unsubstituted C₁-C₅alkylene group, a substituted or unsubstituted C₂-C₅ alkenylene group, a substituted or unsubstituted C₂-C₅ alkynylene group, or a substituted or unsubstituted C₃-C₅ dienylene group, and during substitution, a substituent is a halogen atom. By selecting the nitrogen-containing heterocyclic compound within the above range, the cycling performance and storage performance of the secondary battery can be further improved.

In some embodiments of this application, the electrolyte further includes an isocyanate compound, and based on the total mass of the electrolyte, a mass percentage d of the isocyanate compound is 0.01% to 2%. By controlling the mass percentage d of the isocyanate compound within the above range, the cycling performance of the secondary battery can be improved.

In some embodiments of this application, a ratio of a to d is in a range of 2 to 60. By controlling the ratio of a to d within the above range, the cycling performance and storage performance of the secondary battery can be further improved.

In some embodiments of this application, the isocyanate compound includes the following compound represented by formula (III) or formula (IV):

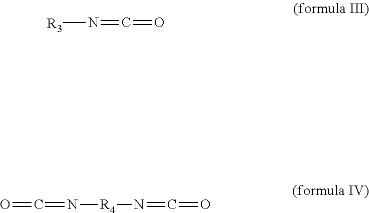

where the isocyanate compound includes at least one-NCO group, and R₃ and R₄ are each independently selected from a C₁-C₇ hydrocarbon group or a C₁-C₇ aromatic hydrocarbon group. By selecting the isocyanate compound within the above range, the cycling performance and storage performance of the secondary battery can be further improved.

In some embodiments of this application, the electrolyte further includes an acid anhydride compound, and based on the total mass of the electrolyte, a mass percentage e of the acid anhydride compound is 0.01% to 2%. By controlling the mass percentage e of the acid anhydride compound within the above range, the cycling performance of the secondary battery can be improved.

In some embodiments of this application, a ratio of a to e is in a range of 2 to 60. By controlling the ratio of a to e within the above range, the cycling performance and storage performance of the secondary battery can be further improved.

In some embodiments of this application, the acid anhydride compound includes at least one of maleic anhydride, dimethylmaleic anhydride, citraconic anhydride, glutaric anhydride, succinic anhydride, itaconic anhydride, biphenyl anhydride, pyridine dicarboxylic anhydride, pyrazine dicarboxylic anhydride, 2,3-pyridine dicarboxylic anhydride, pyridine-3,4-dicarboxylic anhydride, or 2,3-pyrazine dicarboxylic anhydride. By selecting the acid anhydride compound within the above range, the cycling performance and storage performance of the secondary battery can be further improved.

In some embodiments of this application, the electrolyte further includes a silane compound, and based on the total mass of the electrolyte, a mass percentage f of the silane compound is 0.01% to 2%. By controlling the mass percentage f of the silane compound within the above range, the cycling performance of the secondary battery can be improved.

In some embodiments of this application, a ratio of a to f is in a range of 2 to 60. By controlling the ratio of a to f within the above range, the cycling performance, storage performance, and kinetic performance of the secondary battery can be further improved.

In some embodiments of this application, the silane compound includes at least one of tetramethyldivinyldisiloxane, bis(trimethylsilyl) maleate, diphenyldifluorosilane, heptamethyldisilazane, tetramethyldivinyldisiloxane, tetraethoxysilane, 2-cyanoethyltriethoxysilane, 1,3,5,7-tetravinyl-1,3,5,7-tetramethylcyclotetrasiloxane, 2,4,6-trivinyl-2,4,6-trimethylcyclotrisiloxane, or vinyltriethoxysilane. By selecting the silane compound within the above range, the cycling performance, storage performance, and kinetic performance of the secondary battery can be further improved.

In some embodiments of this application, the electrolyte further includes a nitrogen-containing heterocyclic boron trifluoride complex, and based on the total mass of the electrolyte, a mass percentage g of the nitrogen-containing heterocyclic boron trifluoride complex is 0.01% to 1%. By controlling the mass percentage g of the nitrogen-containing heterocyclic boron trifluoride complex within the above range, the cycling performance of the secondary battery can be improved.

In some embodiments of this application, a ratio of a to g is in a range of 2 to 60. By controlling the ratio of a to g within the above range, the cycling performance and storage performance of the secondary battery can be further improved.

In some embodiments of this application, the nitrogen-containing heterocyclic boron trifluoride complex includes at least one of boron trifluoride pyridine, boron trifluoride pyrazine, boron trifluoride pyridazine, 2-fluoropyridine boron trifluoride complex, boron trifluoride pyrimidine, boron trifluoride pyrrole, boron trifluoride pyrazole, or boron trifluoride imidazole. By selecting the nitrogen-containing heterocyclic boron trifluoride complex within the above range, the cycling performance and storage performance of the secondary battery can be further improved.

In some embodiments of this application, the positive electrode active material includes at least one of lithium iron phosphate or lithium manganese iron phosphate.

A second aspect of this application provides an electronic device including the secondary battery according to any one of the foregoing embodiments. Therefore, the electronic device provided in this application has good use performance.

Beneficial effects of this application are as follows.

This application provides a secondary battery and an electronic device. The secondary battery includes a positive electrode plate, a negative electrode plate, and an electrolyte. The electrolyte includes vinylene carbonate, and based on a total mass of the electrolyte, a mass percentage a of the vinylene carbonate is 0.1% to 3%. The positive electrode plate includes a positive electrode active material. The positive electrode active material includes carbon element, and based on a total mass of the positive electrode active material, a mass percentage b of the carbon element is 0.5% to 6%. The secondary battery provided in this application satisfies the above characteristics, enabling simultaneous enhancement of ion conductivity and electron conductivity of the secondary battery, as well as reduction of a consumption rate of the electrolyte, thereby allowing the secondary battery to possess excellent kinetic performance while exhibiting good cycling performance and storage performance.

### DETAILED DESCRIPTION

To make the objectives, technical solutions, and advantages of this application clearer, this application is further described in detail below with reference to the accompanying drawings and embodiments. Apparently, the described embodiments are merely some embodiments rather than all embodiments of this application. All other embodiments obtained by persons of ordinary skill in the art based on some embodiments in this application fall within the protection scope of this application.

It should be noted that in the following content, an example in which a lithium-ion battery is used as a secondary battery is used to illustrate this application. However, the secondary battery of this application is not limited to the lithium-ion battery. Specific technical solutions are as follows.

A first aspect of this application provides a secondary battery including a positive electrode plate, a negative electrode plate, and an electrolyte. The electrolyte includes vinylene carbonate, and based on a total mass of the electrolyte, a mass percentage a of the vinylene carbonate is 0.1% to 3%. The positive electrode plate includes a positive electrode active material. The positive electrode active material includes carbon element, and based on a total mass of the positive electrode active material, a mass percentage b of the carbon element is 0.5% to 6%.

The inventors have found that carbon coating is commonly used to enhance the electron conductivity and ion conductivity of the positive electrode active material; however, carbon coating increases an active reaction area between the positive electrode active material and the electrolyte, leading to increased side reactions. Vinylene carbonate, with a low oxidation potential, can form a film on a surface of the positive electrode active material at a relatively fast rate, suppressing side reactions between the positive electrode material and the electrolyte. By adding a specific amount of vinylene carbonate to the secondary battery while the positive electrode active material contains a specific amount of carbon element, the ion conductivity and electron conductivity of the secondary battery can be simultaneously enhanced, and a consumption rate of the electrolyte can be reduced, thereby allowing the secondary battery to possess excellent kinetic performance while exhibiting good cycling performance and storage performance.

Specifically, the mass percentage a of the vinylene carbonate may be 0.1%, 0.2%, 0.4%, 0.5%, 0.6%, 0.8%, 1%, 1.2%, 1.4%, 1.6%, 1.8%, 2%, 2.2%, 2.4%, 2.5%, 2.6%, 2.8%, 3%, or a range defined by any two of these values. Preferably, a is 0.1% to 2.5%. More preferably, a is 0.5% to 2.5%. Further preferably, a is 0.8% to 2.5%. The mass percentage b of the carbon element may be 0.5%, 1%, 1.5%, 2%, 2.5%, 3%, 3.5%, 4%, 4.5%, 5%, 5.5%, 6%, or a range defined by any two of these values. Preferably, b is 0.5% to 5%. More preferably, b is 0.5% to 4.5%. When the mass percentage of the vinylene carbonate is too low (for example, below 0.1%), protective films formed on surfaces of the positive and negative electrodes are insufficient, failing to suppress interface side reactions and transition metal dissolution, thereby resulting in insignificant improvement in cycling performance and high-temperature storage performance of the secondary battery. When the mass percentage of the vinylene carbonate is too high (for example, above 3%), an interface film-forming impedance of the positive and negative electrodes becomes too large, leading to poor charge and discharge performance, and the charge and discharge performance is especially poor at low temperatures. When the mass percentage of the carbon element is too low (for example, below 0.5%), kinetic performance is poor; when the mass percentage of the carbon element is too high (for example, above 6%), cycling performance and storage performance are poor. By controlling the mass percentages of the vinylene carbonate in the electrolyte and the carbon element in the positive electrode active material within the ranges provided in this application, a film can be formed through polymerization on the surface of the positive electrode, and a stable solid electrolyte interface film is also formed at an interface of the negative electrode, enabling the secondary battery to possess excellent kinetic performance while exhibiting good cycling performance and storage performance.

In the secondary battery provided in this application, the electrolyte includes vinylene carbonate, and the positive electrode active material includes carbon element. By controlling the mass percentages of the vinylene carbonate and the carbon element within the ranges provided in this application, the vinylene carbonate exhibits high film-forming efficiency, capable of forming a high-quality electrolyte interface film on a surface of the carbon-coated positive electrode to effectively protect the interface. Additionally, carbon coating can enhance the ion conductivity of the positive electrode active material, thereby preventing deterioration of interface impedance. The synergy of the vinylene carbonate and the carbon element enables the secondary battery to possess excellent kinetic performance while exhibiting good cycling performance and storage performance.

In this application, a ratio of a to b represents a percentage of the vinylene carbonate corresponding to a unit carbon percentage, and further indicates a formation situation of a solid electrolyte interface film on the carbon applied on the surface of the positive electrode. In some embodiments of this application, the ratio of a to b is 0.22 to 6. Specifically, the ratio of a to b may be 0.22, 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, or a range defined by any two of these values. By controlling the ratio of a to b within the above range, a high-quality electrolyte interface film can be formed on the surface of the positive electrode, a consumption rate of the electrolyte can be reduced, and deterioration of interface impedance can also be prevented, thereby enabling the secondary battery to possess good cycling performance, storage performance, and kinetic performance.

In some embodiments of this application, the electrolyte further includes a nitrogen-containing heterocyclic compound, and based on the total mass of the electrolyte, a mass percentage c of the nitrogen-containing heterocyclic compound is 0.01% to 1%. Specifically, c may be 0.01%, 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1%, or a range defined by any two of these values. By adding the nitrogen-containing heterocyclic compound to the electrolyte, a stable solid electrolyte interface film can be formed on a surface of the negative electrode during formation, suppressing reductive decomposition of other components in the electrolyte on the surface of the negative electrode, thereby improving the cycling performance of the secondary battery, and also suppressing gas production during storage and cycling. Additionally, a good positive electrode electrolyte interface film can be formed at an interface of the positive electrode, suppressing decomposition and consumption of the electrolyte at the positive electrode. Moreover, the nitrogen-containing heterocyclic compound in the electrolyte can react with trace water or HF, removing trace water and HF from the electrolyte, reducing interface side reactions, and reducing dissolution of transition metals in the positive electrode, thereby suppressing gas production and improving cycling performance and safety performance. By controlling the mass percentage c of the nitrogen-containing heterocyclic compound within the above range, appropriate negative electrode interface impedance and good charge and discharge performance can be achieved, the electrolyte interface films on the surfaces of the positive and negative electrodes can be strengthened, and the cycling performance of the secondary battery is improved.

In some embodiments of this application, a ratio of a to c is in a range of 2 to 60. By controlling the ratio of a to c within the above range, the cycling performance and storage performance of the secondary battery can be further improved.

In some embodiments of this application, the nitrogen-containing heterocyclic compound includes the following compound represented by formula (I) or formula (II):

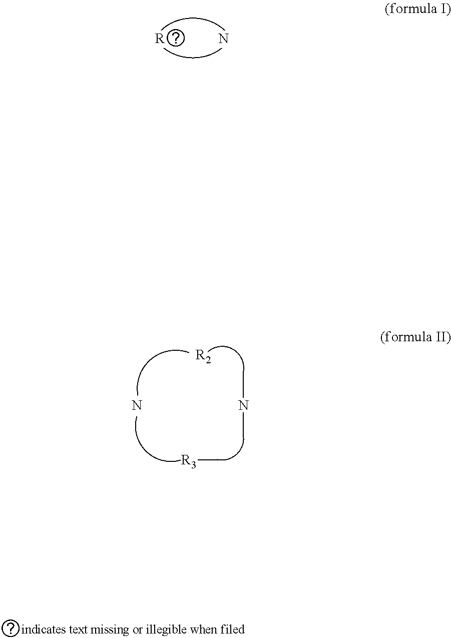

where R₁, R₂, and R₃ are each independently selected from any one of a substituted or unsubstituted C₁-C₅alkylene group, a substituted or unsubstituted C₂-C₅ alkenylene group, a substituted or unsubstituted C₂-C₅ alkynylene group, or a substituted or unsubstituted C₃-C₅ dienylene group, and during substitution, a substituent is a halogen atom.

By selecting the nitrogen-containing heterocyclic compound within the above range, the cycling performance and storage performance of the secondary battery can be further improved.

In some embodiments of this application, the electrolyte further includes an isocyanate compound, and based on the total mass of the electrolyte, a mass percentage d of the isocyanate compound is 0.01% to 2%. Specifically, d may be 0.01%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, or a range defined by any two of these values. Due to the reactive nature, the isocyanate compound readily reacts with water, acid, and the like, thereby providing a certain water and acid removal effect. By adding the isocyanate compound to the electrolyte, generation of HF in the electrolyte can be effectively reduced, and dissolution of transition metals in the positive electrode can be reduced, thereby suppressing gas production and improving cycling performance and safety performance. By controlling the mass percentage d of the isocyanate compound within the above range, appropriate negative electrode interface impedance and good charge and discharge performance can be achieved, the electrolyte interface films on the surfaces of the positive and negative electrodes can be strengthened, and the cycling performance of the secondary battery is improved.

In some embodiments of this application, a ratio of a to d is in a range of 2 to 60. By controlling the ratio of a to d within the above range, the cycling performance and storage performance of the secondary battery can be further improved.

In some embodiments of this application, the isocyanate compound includes the following compound represented by formula (III) or formula (IV):

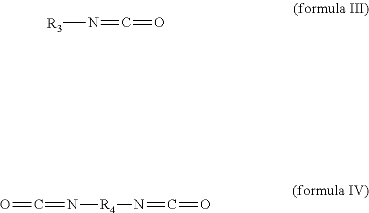

where the isocyanate compound includes at least one-NCO group, and R₃ and R₄ are each independently selected from a C₁-C₇ hydrocarbon group or a C₁-C₇ aromatic hydrocarbon group.

By selecting the isocyanate compound within the above range, the cycling performance and storage performance of the secondary battery can be further improved.

In some embodiments of this application, the electrolyte further includes an acid anhydride compound, and based on the total mass of the electrolyte, a mass percentage e of the acid anhydride compound is 0.01% to 2%. Specifically, e may be 0.01%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, or a range defined by any two of these values. The acid anhydride compound can neutralize residual alkaline groups on a surface of the positive electrode material, reducing decomposition of carbonate solvents by alkali. Besides, the acid anhydride can react with trace water in the secondary battery, generating organic acid substances, reducing formation of strong acids, and thus reducing damage to materials caused by the strong acids. Therefore, the acid anhydride compound has the effects of improving high-temperature performance and reducing gas production in the battery. By adding the acid anhydride compound to the electrolyte, the cycling performance of the secondary battery can be improved, and gas production during storage and cycling is also suppressed. By controlling the mass percentage e of the acid anhydride compound within the above range, appropriate negative electrode interface impedance and good charge and discharge performance can be achieved, the electrolyte interface films on the surfaces of the positive and negative electrodes can be strengthened, and the cycling performance of the secondary battery is improved.

In some embodiments of this application, a ratio of a to e is in a range of 2 to 60. By controlling the ratio of a to e within the above range, the cycling performance and storage performance of the secondary battery can be further improved.

In some embodiments of this application, the acid anhydride compound includes at least one of maleic anhydride, dimethylmaleic anhydride, citraconic anhydride, glutaric anhydride, succinic anhydride, itaconic anhydride, biphenyl anhydride, pyridine dicarboxylic anhydride, pyrazine dicarboxylic anhydride, 2,3-pyridine dicarboxylic anhydride, pyridine-3,4-dicarboxylic anhydride, or 2,3-pyrazine dicarboxylic anhydride. By selecting the acid anhydride compound within the above range, the cycling performance and storage performance of the secondary battery can be further improved.

In some embodiments of this application, the electrolyte further includes a silane compound, and based on the total mass of the electrolyte, a mass percentage f of the silane compound is 0.01% to 2%. Specifically, f may be 0.01%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, or a range defined by any two of these values. The silane compound can react with H₂O or HF, providing effective water and acid removal functions, thereby blocking sustained occurrence of subsequent side reactions. Additionally, such additives can form a stable and low-impedance interface film at the interface, thereby improving the electrochemical performance of the secondary battery. By controlling the mass percentage f of the silane compound within the above range, film formation of the vinylene carbonate is facilitated, compactness of formed film is enhanced, the electrolyte interface films on the surfaces of the positive and negative electrodes are strengthened, good water and acid removal effects are provided, and the cycling performance of the secondary battery is improved.

In some embodiments of this application, a ratio of a to f is in a range of 2 to 60. By controlling the ratio of a to f within the above range, the cycling performance, storage performance, and kinetic performance of the secondary battery can be further improved.

In some embodiments of this application, the silane compound includes at least one of tetramethyldivinyldisiloxane, bis(trimethylsilyl) maleate, diphenyldifluorosilane, heptamethyldisilazane, tetramethyldivinyldisiloxane, tetraethoxysilane, 2-cyanoethyltriethoxysilane, 1,3,5,7-tetravinyl-1,3,5,7-tetramethylcyclotetrasiloxane, 2,4,6-trivinyl-2,4,6-trimethylcyclotrisiloxane, or vinyltriethoxysilane. By selecting the silane compound within the above range, the cycling performance, storage performance, and kinetic performance of the secondary battery can be further improved.

In some embodiments of this application, the electrolyte further includes a nitrogen-containing heterocyclic boron trifluoride complex, and based on the total mass of the electrolyte, a mass percentage g of the nitrogen-containing heterocyclic boron trifluoride complex is 0.01% to 1%. Specifically, g may be 0.01%, 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1%, or a range defined by any two of these values. The nitrogen-containing heterocyclic boron trifluoride complex contains two active functional groups: a Lewis acid —BF₃ and a nitrogen-containing heterocyclic organic base. The nitrogen-containing heterocyclic organic base portion can not only neutralize acidic substances in the electrolyte but also coordinate with transition metal ions in the electrolyte, suppressing their side reactions on the surface of the negative electrode. The —BF₃, as a boron-containing Lewis acid, serves as an anion receptor, increasing dissociation degree of lithium salts and migration of lithium ions, thereby reducing impedance. By adding the nitrogen-containing heterocyclic boron trifluoride complex to the electrolyte, interface side reactions can be reduced, and the impact of transition metals on the negative electrode can be reduced, thereby improving the cycling and storage performance of the secondary battery. By controlling the mass percentage g of the nitrogen-containing heterocyclic boron trifluoride complex within the above range, appropriate negative electrode interface impedance and good charge and discharge performance can be achieved, the electrolyte interface films on the surfaces of the positive and negative electrodes can be strengthened, and the cycling performance of the secondary battery is improved.

In some embodiments of this application, a ratio of a to g is in a range of 2 to 60. By controlling the ratio of a to g within the above range, the cycling performance and storage performance of the secondary battery can be further improved.

In some embodiments of this application, the nitrogen-containing heterocyclic boron trifluoride complex includes at least one of boron trifluoride pyridine, boron trifluoride pyrazine, boron trifluoride pyridazine, 2-fluoropyridine boron trifluoride complex, boron trifluoride pyrimidine, boron trifluoride pyrrole, boron trifluoride pyrazole, or boron trifluoride imidazole. By selecting the nitrogen-containing heterocyclic boron trifluoride complex within the above range, the cycling performance and storage performance of the secondary battery can be further improved.

The electrolyte of the secondary battery of this application further includes a lithium salt and a non-aqueous solvent. The lithium salt may include various lithium salts commonly used in the art, for example, at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato) borate (LiBOB), or lithium difluoroborate. A concentration of the lithium salt in the electrolyte is not particularly limited in this application, provided that the objectives of this application can be achieved. For example, the concentration of the lithium salt in the electrolyte is 0.4 mol/L to 2 mol/L, and preferably, the concentration of the lithium salt in the electrolyte is 0.5 mol/L to 1.2 mol/L. For example, the concentration of the lithium salt in the electrolyte may be 0.4 mol/L, 0.6 mol/L, 0.8 mol/L, 1 mol/L, 1.2 mol/L, 1.4 mol/L, 1.6 mol/L, 1.8 mol/L, 2 mol/L, or a range defined by any two of these values. The non-aqueous solvent is not particularly limited in this application, provided that the objectives of this application can be achieved. For example, the non-aqueous solvent may include but is not limited to at least one of a carbonate compound, a carboxylate compound, an ether compound, or other organic solvents. The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethylene propyl carbonate (EPC), or methyl ethyl carbonate (MEC). The cyclic carbonate compound may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. A mass percentage of the above non-aqueous solvent in the electrolyte may be 70% to 95%, for example, 70%, 75%, 80%, 85%, 90%, 95%, or a range defined by any two of these values.

In this application, the secondary battery further includes a positive electrode plate, where the positive electrode plate includes a positive electrode current collector and a positive electrode material layer disposed on at least one surface of the positive electrode current collector. The phrase “positive electrode material layer disposed on at least one surface of the positive electrode current collector” means that the positive electrode material layer may be disposed on one surface of the positive electrode current collector in a thickness direction of the positive electrode current collector, or on two surfaces of the positive electrode current collector in the thickness direction of the positive electrode current collector. It should be noted that the “surface” herein may be an entire region of the positive electrode current collector or a partial region of the positive electrode current collector. This is not particularly limited in this application, provided that the objectives of this application can be achieved. The positive electrode current collector is not particularly limited in this application, provided that the objectives of this application can be achieved. For example, the positive electrode current collector may include aluminum foil, aluminum alloy foil, or a composite current collector (for example, an aluminum-carbon composite current collector).

The positive electrode material layer includes a positive electrode active material, and the positive electrode active material of this application may include at least one of lithium iron phosphate or lithium manganese iron phosphate. The positive electrode active material of this application may have a coating on a surface thereof or may be mixed with another compound having a coating. This application has no particular limitation on the another compound, provided that the objectives of this application can be achieved. For example, the another compound may be at least one of lithium nickel cobalt manganese oxide (for example, common NCM811, NCM622, NCM523, and NCM111), lithium nickel cobalt aluminate, lithium iron phosphate, lithium-rich manganese-based material, lithium cobalt oxide (LiCoO₂), lithium manganese oxide, lithium manganese iron phosphate, or lithium titanate. The coating may include at least one of an oxide of a coating element, a hydroxide of a coating element, a hydroxyoxide of a coating element, an oxycarbonate (oxycarbonate) of a coating element, or a hydroxycarbonate (hydroxycarbonate) of a coating element. The compound may be non-crystalline or crystalline. The coating element may include one or more of Mg, Al, Co, K, Na, Ca, Si, Ti, V, Sn, Ge, Ga, B, As, or Zr. This application has no particular limitation on a method for applying the coating, provided that the objectives of this application can be achieved. For example, spraying or immersion may be adopted.

The positive electrode material layer further includes a conductive agent and a binder. This application has no particular limitation on types of the conductive agent and the binder, provided that the objectives of this application can be achieved. For example, the binder may include but is not limited to at least one of polyvinyl alcohol, hydroxypropyl cellulose, polyvinylidene fluoride, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene 1,1-difluoroethylene, polyethylene, polypropylene, styrene-butadiene rubber, acrylic (acrylate) styrene-butadiene rubber, epoxy resin, or nylon; and the conductive agent may include but is not limited to at least one of a carbon-based material, a metal-based material, a conductive polymer, or a mixture of these substances. For example, the carbon-based material may include natural graphite, artificial graphite, carbon black, acetylene black, Ketjen black, carbon fiber, or any combination thereof; the metal-based material may include metal powder, metal fiber, copper, nickel, aluminum, or silver; and the conductive polymer may include a polyphenylene derivative. A mass ratio of the positive electrode active material, the conductive agent, and the binder in the positive electrode material layer is not particularly limited in this application, and persons skilled in the art can make selections based on actual needs, provided that the objectives of this application can be achieved. Thicknesses of the positive electrode current collector and the positive electrode material layer are not particularly limited in this application, provided that the objectives of this application can be achieved. For example, the thickness of the positive electrode current collector is 6 μm to 12 μm, and the thickness of the positive electrode material layer is 30 μm to 120 μm. A thickness of the positive electrode plate is not particularly limited in this application, provided that the objectives of this application can be achieved. For example, the thickness of the positive electrode plate is 50 μm to 150 μm. Optionally, the positive electrode plate may further include a conductive layer, and the conductive layer is located between the positive electrode current collector and the positive electrode material layer. A composition of the conductive layer is not particularly limited and may be a conductive layer commonly used in the art. The conductive layer includes a conductive agent and a binder.

This application has no particular limitation on a preparation process of the positive electrode active material, provided that the objectives of this application can be achieved. In one example, the positive electrode active material is prepared using the following method: Li₂C₂O₄, FeC₂O₄·2H₂O, and NH₄H₂PO₄ are proportioned according to a stoichiometric ratio of LifePO₄, followed by dry grinding for 40 h to 50 h to obtain a precursor. Carbon sources having different mass percentages are added to the obtained precursor, followed by wet grinding for 5 h to 6 h. A resulting solid-liquid mixture is dried on a spray dryer, and dried powder is pre-sintered at 500° C. to 600° C. in a tube furnace in an N2 protective atmosphere for 5 h to 7 h, then further heated, and sintered at 600° C. to 700° C. for 10 h to 12 h to obtain a carbon-containing LiFePO₄ sample. The carbon sources may include but are not limited to at least one of glucose, sucrose, graphite, or starch.

This application has no particular limitation on a method for controlling a percentage of the carbon element in the positive electrode active material, provided that the objectives of this application can be achieved. For example, the percentage of the carbon element in the positive electrode active material generally increases with an increase in the percentages of the different carbon sources added such as glucose. The percentage of the carbon element in the positive electrode active material can be adjusted by adjusting the percentage of the carbon source during preparation.

In this application, the secondary battery further includes a negative electrode plate, where the negative electrode plate includes a negative electrode current collector and a negative electrode active material layer disposed on at least one surface of the negative electrode current collector. This application has no particular limitation on the negative electrode current collector, provided that the objectives of this application can be achieved. For example, the negative electrode current collector may include copper foil, copper alloy foil, nickel foil, stainless steel foil, titanium foil, foamed nickel, foamed copper, or a composite current collector. The negative electrode active material layer in this application includes a negative electrode active material, a conductive agent, and a binder. The negative electrode active material of this application may include at least one of natural graphite, artificial graphite, mesocarbon microbeads (MCMB), hard carbon, soft carbon, silicon, silicon-carbon composite, SiOₓ (0.5<x<1.6), Li—Sn alloy, Li—Sn—O alloy, Sn, SnO, SnO₂, spinel-structured lithium titanate Li₄Ti₅O₁₂, Li—Al alloy, or metallic lithium. This application has no particular limitation on types of the binder and the conductive agent, provided that the objectives of this application can be achieved. For example, the binder and the conductive agent may include but are not limited to at least one of the substances mentioned above. In this application, thicknesses of the negative electrode current collector and the negative electrode active material layer are not particularly limited, provided that the objectives of this application can be achieved. For example, the thickness of the negative electrode current collector is 6 μm to 10 μm, and the thickness of the negative electrode active material layer is 30 μm to 120 μm. In this application, a thickness of the negative electrode plate is not particularly limited, provided that the objectives of this application can be achieved. For example, the thickness of the negative electrode plate is 50 μm to 150 μm. Optionally, the negative electrode plate may further include a conductive layer, and the conductive layer is located between the negative electrode current collector and the negative electrode active material layer. A composition of the conductive layer is not particularly limited, and the conductive layer may be a conductive layer commonly used in the art. The conductive layer includes a conductive agent and a binder.

In this application, the secondary battery further includes a separator configured to separate the positive electrode plate and the negative electrode plate, thereby preventing an internal short circuit in the secondary battery, and allowing electrolyte ions to pass through freely, without affecting an electrochemical charge-discharge process. This application has no particular limitation on the separator, provided that the objectives of this application can be achieved. For example, a material of the separator may include but is not limited to at least one of polyethylene (PE) and polypropylene (PP)-based polyolefin (PO), polyester (for example, polyethylene terephthalate (PET) film), cellulose, polyimide (PI), polyamide (PA), spandex, or aramid. A type of the separator may include at least one of a woven film, a non-woven film, a microporous film, a composite film, a laminated film, or a spun film.

For example, the separator may include a substrate layer and a surface treatment layer. The substrate layer may be a non-woven fabric, film, or composite film having a porous structure, and a material of the substrate layer may include at least one of polyethylene, polypropylene, polyethylene glycol terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, the surface treatment layer is disposed on at least one surface of the substrate layer, and the surface treatment layer may be a polymer layer or an inorganic substance layer, or a layer formed by mixing a polymer and an inorganic substance. For example, the inorganic substance layer includes inorganic particles and a binder. The inorganic particles are not particularly limited, and for example, may include at least one of aluminum oxide, silicon oxide, magnesium oxide, titanium oxide, hafnium dioxide, tin oxide, spinel structure, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited, and may be, for example, at least one of the foregoing binders. The polymer layer includes a polymer, and a material of the polymer includes at least one of polyamide, polyacrylonitrile, an acrylate polymer, polyacrylic acid, a polyacrylate, polyvinylpyrrolidone, polyvinyl ether, polyvinylidene fluoride, or poly(vinylidene fluoride-hexafluoropropylene).

The secondary battery of this application further includes a packaging bag configured to accommodate the positive electrode plate, the separator, the negative electrode plate, and the electrolyte, as well as other components known in the field of secondary batteries, and this application has no limitation on the above other components. The packaging bag is not particularly limited in this application, which may be a packaging bag known in the art, provided that the objectives of this application can be achieved.

The secondary battery of this application is not particularly limited and may include any device in which electrochemical reactions take place. In some embodiments, the secondary battery may include but is not limited to a lithium metal secondary battery, a lithium-ion secondary battery (lithium-ion battery), a lithium polymer secondary battery, or a lithium-ion polymer secondary battery.

A preparation process of the secondary battery of this application is well known to persons skilled in the art and is not particularly limited in this application. For example, the preparation process may include but is not limited to the following steps: stacking a positive electrode plate, a separator, and a negative electrode plate in sequence and performing operations such as winding and folding as needed to obtain an electrode assembly of a wound structure, placing the electrode assembly into a packaging bag, injecting an electrolyte into the packaging bag, and sealing the packaging bag to obtain a secondary battery; alternatively, stacking a positive electrode plate, a separator, and a negative electrode plate in sequence, fixing four corners of an entire laminated structure with tapes to obtain an electrode assembly of a laminated structure, placing the electrode assembly into a packaging bag, injecting an electrolyte into the packaging bag, and sealing the packaging bag to obtain a secondary battery. In addition, an overcurrent prevention element, a guide plate, and the like may also be placed into the packaging bag as needed to prevent pressure increase, overcharge, and overdischarge inside the secondary battery.

A second aspect of this application provides an electronic device including the secondary battery according to any one of the foregoing embodiments. Therefore, the electronic device provided in this application has good use performance.

The electronic device of this application is not particularly limited and may be any electronic device known in the prior art. In some embodiments, the electronic device may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household storage battery, or a lithium-ion capacitor.

### EXAMPLES

The following provides examples and comparative examples to describe some embodiments of this application more specifically. Various tests and evaluations are conducted according to the methods described below. In addition, unless otherwise specified, “part” and “%” are based on mass.

### Test Methods and Equipment

### Carbon Element Percentage Test

For positive electrode active material powder, a percentage of carbon element in the powder was tested directly using a carbon-sulfur analyzer.

For a positive electrode plate that was prepared or removed from a lithium-ion battery, a coated region of the electrode plate was cut into pieces; after ultrasonic vibration was performed in an NMP bath at 100° C. for 48 h, a current collector was removed; remaining substances were ground for 1 h, washed and filtered three times to remove gelatinous substances; remaining solid substances were dried at 100° C. for 8 h; and a percentage of carbon element in obtained powder was tested using a carbon-sulfur analyzer.

### Cycling Performance Test

A lithium-ion battery was placed in a 45° C. thermostat and left standing for 30 min until the lithium-ion battery reached a constant temperature of 45° C. The lithium-ion battery was charged at a constant current of 1 C to 3.65 V, then charged at a constant voltage of 3.65 V until a current reached 0.05 C, and subsequently discharged at a constant current of 1 C to 2.5 V; and this process was defined as one charge-discharge cycle. A capacity of a first discharge was taken as 100%, charge-discharge cycles were repeated until a discharge capacity decayed to 70%, the test was stopped, and the number of cycles was recorded as an indicator for evaluating cycling performance of the lithium-ion battery.

Simultaneously, the cycling performance of the lithium-ion battery at 60° C. was tested. The lithium-ion battery was placed in a 60° C. thermostat, and left standing for 30 minutes to reach a constant temperature of 60° C., followed by charge-discharge cycle steps which were the same as the foregoing charge-discharge cycle steps at 45° C.

### High-Temperature Storage Test at 100% State of Charge (SOC)

A lithium-ion battery was placed in a 25° C. thermostat and left standing for 30 min until the lithium-ion battery reached a constant temperature of 25° C. The lithium-ion battery was charged at a constant current of 1 C to 3.65 V, charged at a constant voltage until a current reached 0.05 C, and then discharged at a constant current of 1 C to 2.5 V, and a discharge capacity was recorded as an initial capacity Co. Subsequently, the lithium-ion battery was charged at a constant current of 0.5 C to 3.65 V, and charged at a constant voltage until a current reached 0.05 C, and a thickness T₀ of the battery was measured and recorded using a micrometer. The lithium-ion battery was transferred to a 60° C. thermostat for storage for 90 days, during which the thickness of the thickness was measured and recorded every 30 days. The lithium-ion battery was then transferred to a 25° C. thermostat, left standing for 60 min, and discharged at a constant current of 1 C to 2.5 V, and a discharge capacity was recorded as a remaining capacity C₁. Then, the lithium-ion battery was charged at a constant current of 1 C to 3.65 V, charged at a constant voltage until a current reached 0.05 C, and then discharged at a constant current of 1 C to 2.5 V, a discharge capacity was recorded as a recovered capacity C₂, and a thickness T₁, an open-circuit voltage, and an impedance of the lithium-ion battery were measured. A remaining capacity retention rate and a recovered capacity retention rate of the lithium-ion battery were calculated according to the following formulas, as indicators for evaluating high-temperature storage performance of the lithium-ion battery at 100% SOC.

Thickness expansion rate at 100% SOC after high-temperature storage=(T₁−T₀)/T₀×100%.

Remaining capacity retention rate at 100% SOC after high-temperature storage=C₁/C₀×100%.

Recovered capacity retention rate at 100% SOC after high-temperature storage=C₂/C₀×100%.

### High-Temperature Storage Test at 0% SOC

A lithium-ion battery was placed in a 25° C. thermostat and left standing for 30 min until the lithium-ion battery reached a constant temperature of 25° C. The lithium-ion battery was charged at a constant current of 1 C to 3.65 V, charged at a constant voltage until a current reached 0.05 C, and then discharged at a constant current of 1 C to 2.5 V, and a discharge capacity was recorded as an initial capacity C₃. A thickness T₂ of the battery was measured and recorded using a micrometer. The lithium-ion battery was transferred to a 60° C. thermostat for storage for 90 days, during which the thickness of the battery was measured and recorded every 30 days. The lithium-ion battery was then transferred to a 25° C. thermostat, left standing for 60 min, charged at a constant current of 1 C to 3.65 V, charged at a constant voltage until a current reached 0.05 C, and then discharged at a constant current of 1 C to 2.5 V, a discharge capacity was recorded as a recovered capacity C₄, and a thickness T₃, an open-circuit voltage, and an impedance of the lithium-ion battery were measured. A thickness expansion rate of the lithium-ion battery was calculated according to the following formula, as an indicator for evaluating high-temperature storage performance of the lithium-ion battery at 0% SOC.

Thickness expansion rate at 0% SOC after high-temperature storage=(T₃−T₂)/T₂×100%.

### Direct Current Resistance (DCR) Test

A lithium-ion battery was placed in a 0° C. high-low temperature chamber, left standing for 4 h, charged at a constant current of 0.1 C to 3.65 V, charged at a constant voltage until a current reached 0.05 C, left standing for 10 min, discharged at a constant current of 0.1 C to 2.5 V, left standing for 10 min, charged again at a constant current of 0.1 C to 3.65 V, charged at a constant voltage until a current reached 0.05 C, left standing for 10 min, discharged at a constant current of 0.1 C for 3 h, and then discharged at a constant current of 1 C for 1s. A direct current resistance corresponding to a 70% SOC state of the lithium-ion battery was calculated.

### Charge Performance Test

At 25° C., charging and discharging was performed according to the following steps: (1) the lithium-ion battery was left standing for 5 min; (2) the lithium-ion battery was discharged at a constant current of 0.5 C to 2.5 V; (3) the lithium-ion battery was left standing for 15 min; (4) the lithium-ion battery was charged at a constant current of 1.5 C to 3.65 V, and charged at a constant voltage until a current reached 0.05 C; (5) the lithium-ion battery was left standing for 60 min; and (6) steps 3 to 5 were repeated ten times.

A fully charged battery after the test was disassembled, and a degree of lithium precipitation on an interface of a negative electrode plate was observed. If there was significant lithium precipitation on an entire surface of the main body or a capacity retention rate was less than 90% after 10 cycles, it was considered that there was severe lithium precipitation; if there was lithium precipitation in local regions, corners, or the like of the main body, or a capacity retention rate was maintained between 90% and 98% after 10 cycles, it was considered that there was moderate lithium precipitation; if there was lithium precipitation only at corners or head and tail portions of the lithium-ion battery, or a capacity retention rate was greater than 98% but less than or equal to 99.5% after 10 cycles, it was considered that there was slight lithium precipitation; and if all positions are golden yellow, it was considered that there was no lithium precipitation.

### Example 1-1

### <Preparation of Positive Electrode Active Material>

Li₂C₂O₄, FeC₂O₄·2H₂O, and NH₄H₂PO₄ were proportioned according to a stoichiometric ratio of LifePO₄, followed by dry grinding for 40 h to obtain a precursor. A certain amount of glucose was added to the obtained precursor, followed by wet grinding for 5 h to obtain a solid-liquid mixture which was dried on a spray dryer, and dried powder was pre-sintered at 500° C. for 5 h in a tube furnace in an N2 protective atmosphere, then further heated to 600° C. and sintered for 10 h to obtain a LiFePO₄ sample containing 1.5% of carbon. During sintering in the N2 atmosphere, there was a certain degree of carbon percentage loss, approximately 50%.

### <Preparation of Positive Electrode Plate>

LFP, Super P, and PVDF were mixed at a weight ratio of 96.3:1.5:2.2, N-methylpyrrolidone (NMP) was added as a solvent to prepare a slurry with a solid content of 72 wt %, and the slurry was stirred uniformly under vacuum to obtain a positive electrode slurry. The positive electrode slurry was uniformly applied on one surface of a positive electrode current collector aluminum foil with a thickness of 10 μm, and the aluminum foil was dried at 85° C. to obtain a positive electrode plate having one surface coated with a positive electrode material layer, with a coating thickness of 100 μm. The above steps were repeated on the other surface of the aluminum foil to obtain a positive electrode plate having two surfaces coated with the positive electrode material layer. After cold pressing, cutting, and tab welding, the positive electrode plate was dried under vacuum at 85° C. for 4 h to obtain a positive electrode plate with specifications of 74 mm×867 mm for later use.

### <Preparation of Negative Electrode Plate>

Artificial graphite, Super P, sodium carboxymethyl cellulose (CMC), and styrene-butadiene rubber (SBR) were mixed at a weight ratio of 96.4:1.5:0.5:1.6, deionized water was added as a solvent to prepare a slurry with a solid content of 54 wt %, and the slurry was stirred uniformly in a vacuum mixer to obtain a negative electrode slurry. The negative electrode slurry was uniformly applied on one surface of a negative electrode current collector copper foil with a thickness of 10 μm, and the copper foil was dried at 85° C. to obtain a negative electrode plate having one surface coated with a negative electrode material layer, with a coating thickness of 100 μm. The above steps were repeated on the other surface of the copper foil to obtain a negative electrode plate having two surfaces coated with the negative electrode material layer. After cold pressing, cutting, and tab welding, the negative electrode plate was dried under vacuum at 120° C. for 12 h to obtain a negative electrode plate with specifications of 78 mm×875 mm for later use.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent, then vinylene carbonate was added, dissolved, and thoroughly stirred, lithium salt LiPF₆ was added, and the resulting mixture was uniformly mixed to obtain an electrolyte. A mass percentage of LiPF₆ was 12.5%, a mass percentage of the vinylene carbonate was 0.1%, and a mass percentage of the base solvent was 87.4%.

### <Preparation of Separator>

A porous polyethylene film (provided by Celgard) with a thickness of 7 μm was used.

### <Preparation of Lithium-Ion Battery>

A positive electrode plate, a separator, and a negative electrode plate were stacked in sequence so that the separator is located between the positive electrode plate and the negative electrode plate for isolation, and then wound to obtain an electrode assembly. The electrode assembly was placed in an outer packaging foil, moisture was removed at 80° C., and the prepared electrolyte was injected into the outer packaging foil, followed by vacuum sealing, standing, formation (charged at a constant current of 0.02 C to 3.3 V, and then charged at a constant current of 0.1 C to 3.6 V), shaping, and capacity testing, to obtain a pouch lithium-ion battery (with a thickness of 3.3 mm, a width of 39 mm, a length of 96 mm).

### Examples 1-2 to 1-19

Examples 1-2 to 1-19 were the same as Example 1-1 except that in the <preparation of positive electrode active material>, the percentage of carbon element in the positive electrode active material was controlled by adjusting the mass percentage of glucose, and in the <preparation of electrolyte>, relevant preparation parameters were adjusted according to Table 1.

### Example 2-1

Example 2-1 was the same as Example 1-5 except that the electrolyte was prepared according to the method below and relevant preparation parameters were adjusted according to Table 3.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent, vinylene carbonate and pyridine were added, dissolved, and thoroughly stirred, lithium salt LiPF₆ was added, and the resulting mixture was uniformly mixed to obtain an electrolyte. A mass percentage of LiPF₆ was 12.5%, a mass percentage of the vinylene carbonate was 2%, a mass percentage of the pyridine was 0.01%, and a mass percentage of the base solvent was 85.49%.

### Examples 2-2 to 2-11

Examples 2-2 to 2-11 were the same as Example 2-1 except that in the <preparation of electrolyte>, relevant preparation parameters were adjusted according to Table 3.

### Example 3-1

Example 3-1 was the same as Example 1-5 except that the electrolyte was prepared according to the method below and relevant preparation parameters were adjusted according to Table 5.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent, vinylene carbonate and hexamethylene diisocyanate were added, dissolved, and thoroughly stirred, lithium salt LiPF₆ was added, and the resulting mixture was uniformly mixed to obtain an electrolyte. A mass percentage of LiPF₆ was 12.5%, a mass percentage of the vinylene carbonate was 2%, a mass percentage of the hexamethylene diisocyanate was 0.01%, and a mass percentage of the base solvent was 85.49%.

### Examples 3-2 to 3-11

Examples 3-2 to 3-11 were the same as Example 3-1 except that in the <preparation of electrolyte>, relevant preparation parameters were adjusted according to Table 5.

### Example 4-1

Example 4-1 was the same as Example 1-5 except that the electrolyte was prepared according to the method below and relevant preparation parameters were adjusted according to Table 7.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent, vinylene carbonate and maleic anhydride were added, dissolved, and thoroughly stirred, lithium salt LiPF₆ was added, and the resulting mixture was uniformly mixed to obtain an electrolyte. A mass percentage of LiPF₆ was 12.5%, a mass percentage of the vinylene carbonate was 2%, a mass percentage of the maleic anhydride was 0.01%, and a mass percentage of the base solvent was 85.49%.

### Examples 4-2 to 4-11

Examples 4-2 to 4-11 were the same as Example 4-1 except that in the <preparation of electrolyte>, relevant preparation parameters were adjusted according to Table 7.

### Example 5-1

Example 5-1 was the same as Example 1-5 except that the electrolyte was prepared according to the method below and relevant preparation parameters were adjusted according to Table 9.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent, vinylene carbonate and tetramethyldivinyldisiloxane were added, dissolved, and thoroughly stirred, lithium salt LiPF₆ was added, and the resulting mixture was uniformly mixed to obtain an electrolyte. A mass percentage of LiPF₆ was 12.5%, a mass percentage of the vinylene carbonate was 2%, a mass percentage of the tetramethyldivinyldisiloxane was 0.1%, and a mass percentage of the base solvent was 85.4%.

### Examples 5-2 to 5-9

Examples 5-2 to 5-9 were the same as Example 5-1 except that in the <preparation of electrolyte>, relevant preparation parameters were adjusted according to Table 9.

### Example 6-1

Example 6-1 was the same as Example 1-5 except that the electrolyte was prepared according to the method below and relevant preparation parameters were adjusted according to Table 11.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent, vinylene carbonate and boron trifluoride pyridine were added, dissolved, and thoroughly stirred, lithium salt LiPF₆ was added, and the resulting mixture was uniformly mixed to obtain an electrolyte. A mass percentage of LiPF₆ was 12.5%, a mass percentage of the vinylene carbonate was 2%, a mass percentage of the boron trifluoride pyridine was 0.01%, and a mass percentage of the base solvent was 85.49%.

### Examples 6-2 to 6-10

Examples 6-2 to 6-10 were the same as Example 6-1 except that in the <preparation of electrolyte>, relevant preparation parameters were adjusted according to Table 11.

### Comparative Example 1

Comparative Example 1 was the same as Example 1-1 except that the electrolyte was prepared according to the method below.

### <Preparation of Electrolyte>

In a dry argon atmosphere glove box, ethylene carbonate (EC) and ethyl methyl carbonate (EMC) were mixed at a mass ratio of EC:EMC=35:65 to obtain a base solvent in which EC and EMC were thoroughly dissolved, lithium salt LiPF₆ was added, and the resulting mixture was uniformly mixed to obtain an electrolyte. A mass percentage of LiPF₆ was 12.5%, and a mass percentage of the base solvent was 87.5%.

### Comparative Examples 2 to 4

Comparative Examples 2 to 4 were the same as Example 1-1 except that in the <preparation of positive electrode active material>, the percentage of carbon element in the positive electrode active material was controlled by adjusting the mass percentage of glucose, and in the <preparation of electrolyte>, relevant preparation parameters were adjusted according to Table 1.

Preparation parameters and performance tests of the examples and comparative examples are shown in Tables 1 to 12.

TABLE 1

| | a (%) | b (%) | a/b |
|---|---|---|---|
| Example 1-1 | 0.1 | 1.5 | 0.07 |
| Example 1-2 | 0.5 | 1.5 | 0.33 |
| Example 1-3 | 0.8 | 1.5 | 0.53 |
| Example 1-4 | 1 | 1.5 | 0.67 |
| Example 1-5 | 2 | 1.5 | 1.33 |
| Example 1-6 | 2.5 | 1.5 | 1.67 |
| Example 1-7 | 3 | 1.5 | 2.00 |
| Example 1-8 | 2 | 0.5 | 4.00 |
| Example 1-9 | 2 | 1 | 2.00 |
| Example 1-10 | 2 | 2 | 1.00 |
| Example 1-11 | 2 | 3 | 0.67 |
| Example 1-12 | 2 | 4.5 | 0.44 |
| Example 1-13 | 2 | 6 | 0.33 |
| Example 1-14 | 3 | 6 | 0.50 |
| Example 1-15 | 0.1 | 0.5 | 0.20 |
| Example 1-16 | 0.5 | 0.5 | 1.00 |
| Example 1-17 | 3 | 0.5 | 6.00 |
| Example 1-18 | 1 | 3 | 0.33 |
| Example 1-19 | 1 | 5 | 0.20 |
| Comparative | / | 1.5 | / |
| Example 1 | | | |
| Comparative | 0.01 | 0.1 | 0.10 |
| Example 2 | | | |
| Comparative | 6 | 10 | 0.60 |
| Example 3 | | | |
| Comparative | 6 | 0.5 | 12 |
| Example 4 | | | |

Note:
“/” in Table 1 means that a related preparation parameter does not exist.

TABLE 2

| | | | | | Remaining | Recovered | | |
|---|---|---|---|---|---|---|---|---|
| | | | Thickness | Thickness | capacity | capacity | | |
| | | | expansion | expansion | retention | retention | | |
| | | | rate at | rate at 0% | rate at | rate at | | Degree of |
| | | | 100% SOC | SOC after | 100% SOC | 100% SOC | | lithium |
| | Cycles | Cycles | after high- | high- | after high- | after high- | | precipitation |
| | at | at | temperature | temperature | temperature | temperature | DCR | in charge |
| | 45° C. | 60° C. | storage (%) | storage (%) | storage (%) | storage (%) | (mΩ) | performance |
| Example | 610 | 368 | 99 | 123 | 65 | 68.4 | 161 | No lithium |
| 1-1 | | | | | | | | precipitation |
| Example | 785 | 487 | 70 | 96 | 67.8 | 71.3 | 144 | No lithium |
| 1-2 | | | | | | | | precipitation |
| Example | 902 | 557 | 48 | 72 | 70.2 | 73.6 | 131 | No lithium |
| 1-3 | | | | | | | | precipitation |
| Example | 1021 | 632 | 36 | 58 | 72.1 | 74.5 | 122 | No lithium |
| 1-4 | | | | | | | | precipitation |
| Example | 2111 | 1224 | 30 | 41 | 86.9 | 88.8 | 138 | No lithium |
| 1-5 | | | | | | | | precipitation |
| Example | 2789 | 1624 | 28 | 36 | 87.9 | 89.1 | 143 | No lithium |
| 1-6 | | | | | | | | precipitation |
| Example | 3078 | 1816 | 27 | 30 | 88.5 | 89.2 | 149 | Slight |
| 1-7 | | | | | | | | lithium |
| | | | | | | | | precipitation |
| Example | 2559 | 1510 | 25 | 34 | 88.9 | 90.5 | 147 | No lithium |
| 1-8 | | | | | | | | precipitation |
| Example | 2397 | 1440 | 29 | 31 | 87.5 | 89.7 | 143 | No lithium |
| 1-9 | | | | | | | | precipitation |
| Example | 2195 | 1309 | 35 | 24 | 85.3 | 87.2 | 135 | No lithium |
| 1-10 | | | | | | | | precipitation |
| Example | 1988 | 1189 | 41 | 50 | 84.3 | 85.9 | 130 | No lithium |
| 1-11 | | | | | | | | precipitation |
| Example | 1801 | 1013 | 47 | 56 | 82.5 | 84.5 | 126 | No lithium |
| 1-12 | | | | | | | | precipitation |
| Example | 1612 | 979 | 52 | 60 | 81.2 | 83 | 121 | No lithium |
| 1-13 | | | | | | | | precipitation |
| Example | 2861 | 1770 | 43 | 50 | 85.6 | 88.5 | 140 | Slight |
| 1-14 | | | | | | | | lithium |
| | | | | | | | | precipitation |
| Example | 787 | 471 | 90 | 104 | 68.5 | 89.5 | 126 | No lithium |
| 1-15 | | | | | | | | precipitation |
| Example | 1173 | 725 | 78 | 86 | 79.3 | 89.6 | 131 | No lithium |
| 1-16 | | | | | | | | precipitation |
| Example | 3354 | 2002 | 24 | 27 | 89 | 89.7 | 153 | Slight |
| 1-17 | | | | | | | | lithium |
| | | | | | | | | precipitation |
| Example | 915 | 557 | 43 | 48 | 70.1 | 73 | 118 | No lithium |
| 1-18 | | | | | | | | precipitation |
| Example | 868 | 513 | 48 | 52 | 68.4 | 71.7 | 112 | No lithium |
| 1-19 | | | | | | | | precipitation |
| Comparative | 332 | 209 | 168 | 212 | 57.2 | 59.1 | 170 | No lithium |
| Example 1 | | | | | | | | precipitation |
| Comparative | 384 | 276 | 127 | 163 | 59.4 | 64.5 | 163 | No lithium |
| Example 2 | | | | | | | | precipitation |
| Comparative | 443 | 376 | 183 | 189 | 51.6 | 54.3 | 223 | Severe |
| Example 3 | | | | | | | | lithium |
| | | | | | | | | precipitation |
| Comparative | 497 | 405 | 141 | 156 | 54.7 | 57.2 | 209 | Severe |
| Example 4 | | | | | | | | lithium |
| | | | | | | | | precipitation |

From Examples 1-1 to 1-19 and Comparative Examples 1 to 4, it can be seen that in the examples, the mass percentages of the vinylene carbonate and carbon element are all within the ranges provided in this application, whereas Comparative Examples 1 to 4 do not simultaneously satisfy the above characteristics. The lithium-ion batteries in the examples of this application exhibit a larger number of cycles at 45° C. and 60° C., lower thickness expansion rate at 100% SOC after high-temperature storage, lower thickness expansion rate at 0% SOC after high-temperature storage, higher remaining capacity retention rate and recovered capacity retention rate at 100% SOC after high-temperature storage, lower DCR, and lower degree of lithium precipitation, thereby demonstrating that the lithium-ion batteries prepared using the electrolyte and positive electrode active material provided in this application possess excellent kinetic performance while exhibiting good cycling performance and storage performance.

TABLE 3

| | | | Nitrogen-containing heterocyclic compound type and percentage c (%) | | | | | |
|---|---|---|---|---|---|---|---|---|
| | b | a | | 2- | | | | |
| | (%) | (%) | Pyridine | fluoropyridine | Pentafluoropyridine | Pyrazine | Pyridazine | a/c |
| Example | 1.5 | 2 | / | / | / | / | / | / |
| 1-5 | | | | | | | | |
| Example | 1.5 | 2 | 0.01 | / | / | / | / | 200.00 |
| 2-1 | | | | | | | | |
| Example | 1.5 | 2 | 0.1 | 1 | / | / | / | 20.00 |
| 2-2 | | | | | | | | |
| Example | 1.5 | 2 | 0.5 | / | / | / | / | 4.00 |
| 2-3 | | | | | | | | |
| Example | 1.5 | 2 | 1 | / | / | / | / | 2.00 |
| 2-4 | | | | | | | | |
| Example | 1.5 | 2 | / | 0.5 | / | / | / | 4.00 |
| 2-5 | | | | | | | | |
| Example | 1.5 | 2 | / | / | 0.5 | / | / | 4.00 |
| 2-6 | | | | | | | | |
| Example | 1.5 | 2 | / | / | / | 0.5 | / | 4.00 |
| 2-7 | | | | | | | | |
| Example | 1.5 | 2 | / | / | / | / | 0.5 | 4.00 |
| 2-8 | | | | | | | | |
| Example | 1.5 | 0.5 | 0.5 | / | / | / | / | 1.00 |
| 2-9 | | | | | | | | |
| Example | 1.5 | 1 | 0.5 | / | / | / | / | 2.00 |
| 2-10 | | | | | | | | |
| Example | 1.5 | 3 | 0.5 | / | / | / | / | 6.00 |
| 2-11 | | | | | | | | |

Note:
“/” in Table 3 means that a related preparation parameter does not exist.

TABLE 4

| | | | | | Remaining | Recovered | | |
|---|---|---|---|---|---|---|---|---|
| | | | Thickness | Thickness | capacity | capacity | | |
| | | | expansion | expansion | retention | retention | | |
| | | | rate at | rate at 0% | rate at | rate at | | Degree of |
| | | | 100% SOC | SOC after | 100% SOC | 100% SOC | | lithium |
| | Cycles | Cycles | after high- | high- | after high- | after high- | | precipitation |
| | at | at | temperature | temperature | temperature | temperature | DCR | in charge |
| | 45° C. | 60° C. | storage (%) | storage (%) | storage (%) | storage (%) | (mΩ) | performance |
| Example | 2111 | 1224 | 30 | 41 | 86.9 | 88.8 | 138 | No lithium |
| 1-5 | | | | | | | | precipitation |
| Example | 2236 | 1362 | 26 | 35 | 87.8 | 88.9 | 139 | No lithium |
| 2-1 | | | | | | | | precipitation |
| Example | 2681 | 1632 | 18 | 21 | 89.1 | 90.5 | 141 | No lithium |
| 2-2 | | | | | | | | precipitation |
| Example | 3311 | 2024 | 8 | 10 | 91.9 | 92.3 | 145 | No lithium |
| 2-3 | | | | | | | | precipitation |
| Example | 3878 | 2416 | 5 | 5 | 92.5 | 93.2 | 156 | Slight |
| 2-4 | | | | | | | | lithium |
| | | | | | | | | precipitation |
| Example | 3459 | 2156 | 9 | 9 | 92 | 92.5 | 143 | No lithium |
| 2-5 | | | | | | | | precipitation |
| Example | 3267 | 1985 | 11 | 13 | 91.3 | 92 | 140 | No lithium |
| 2-6 | | | | | | | | precipitation |
| Example | 3371 | 2013 | 7 | 9 | 91.8 | 92.2 | 148 | No lithium |
| 2-7 | | | | | | | | precipitation |
| Example | 3462 | 2279 | 6 | 7 | 92.2 | 93 | 151 | No lithium |
| 2-8 | | | | | | | | precipitation |
| Example | 2317 | 1316 | 7 | 10 | 91.2 | 91.9 | 132 | No lithium |
| 2-9 | | | | | | | | precipitation |
| Example | 2861 | 1671 | 7 | 8 | 91.6 | 91 | 137 | No lithium |
| 2-10 | | | | | | | | precipitation |
| Example | 3878 | 2316 | 8 | 9 | 92.4 | 93.2 | 155 | Slight |
| 2-11 | | | | | | | | lithium |
| | | | | | | | | precipitation |

From Examples 2-1 to 2-11, it can be seen that when the types and percentages of the added nitrogen-containing heterocyclic compound are within the ranges provided in this application, the obtained lithium-ion batteries exhibit a larger number of cycles at 45° C. and 60° C., lower thickness expansion rates at 100% SOC and 0% SOC after high-temperature storage, and higher remaining capacity retention rate and recovered capacity retention rate at 100% SOC after high-temperature storage, thereby demonstrating that the lithium-ion batteries prepared using the electrolyte provided in this application can further improve the cycling performance and storage performance.

TABLE 5

| | | | Isocyanate compound type and percentage d (%) | | | | |
|---|---|---|---|---|---|---|---|
| | | | | | p- | | |
| | b | a | Hexamethylene | Toluene | fluorophenyl | | |
| | (%) | (%) | diisocyanate | diisocyanate | isocyanate | 3-isocyanatopropene | a/d |
| Example | 1.5 | 2 | / | / | / | / | / |
| 1-5 | | | | | | | |
| Example | 1.5 | 2 | 0.01 | / | / | / | 200.00 |
| 3-1 | | | | | | | |
| Example | 1.5 | 2 | 0.1 | / | / | / | 20.00 |
| 3-2 | | | | | | | |
| Example | 1.5 | 2 | 0.5 | / | / | / | 4.00 |
| 3-3 | | | | | | | |
| Example | 1.5 | 2 | 1 | / | / | / | 2.00 |
| 3-4 | | | | | | | |
| Example | 1.5 | 2 | 2 | / | / | / | 1.00 |
| 3-5 | | | | | | | |
| Example | 1.5 | 2 | / | 0.5 | / | / | 4.00 |
| 3-6 | | | | | | | |
| Example | 1.5 | 2 | / | / | 0.5 | / | 4.00 |
| 3-7 | | | | | | | |
| Example | 1.5 | 2 | / | / | / | 0.5 | 4.00 |
| 3-8 | | | | | | | |
| Example | 1.5 | 0.5 | 0.5 | / | / | / | 1.00 |
| 3-9 | | | | | | | |
| Example | 1.5 | 1 | 0.5 | / | / | / | 2.00 |
| 3-10 | | | | | | | |
| Example | 1.5 | 3 | 0.5 | / | / | / | 6.00 |
| 3-11 | | | | | | | |

Note:
“/” in Table 5 means that a related preparation parameter does not exist.

TABLE 6

| | | | | | | Recovered | | |
|---|---|---|---|---|---|---|---|---|
| | | | Thickness | Thickness | Remaining | capacity | | |
| | | | expansion | expansion | capacity | retention | | |
| | | | rate at 100% | rate at 0% | retention rate | rate at 100% | | Degree of |
| | | | SOC after | SOC after | at 100% SOC | SOC after | | lithium |
| | Cycles | Cycles | high- | high- | after high- | high- | | precipitation |
| | at | at | temperature | temperature | temperature | temperature | DCR | in charge |
| | 45° C. | 60° C. | storage (%) | storage (%) | storage (%) | storage (%) | (mΩ) | performance |
| Example | 2111 | 1224 | 30 | 41 | 86.9 | 88.8 | 138 | No lithium |
| 1-5 | | | | | | | | precipitation |
| Example | 2196 | 1321 | 28 | 36 | 87.3 | 88.7 | 138 | No lithium |
| 3-1 | | | | | | | | precipitation |
| Example | 2428 | 1498 | 20 | 24 | 88.7 | 90.2 | 140 | No lithium |
| 3-2 | | | | | | | | precipitation |
| Example | 3251 | 1965 | 9 | 12 | 91.3 | 92 | 143 | No lithium |
| 3-3 | | | | | | | | precipitation |
| Example | 3790 | 2324 | 8 | 10 | 92 | 92.7 | 148 | No lithium |
| 3-4 | | | | | | | | precipitation |
| Example | 2297 | 1386 | 12 | 15 | 89.6 | 89.8 | 173 | Severe |
| 3-5 | | | | | | | | lithium |
| | | | | | | | | precipitation |
| Example | 3165 | 1917 | 9 | 10 | 91.9 | 92.4 | 143 | No lithium |
| 3-6 | | | | | | | | precipitation |
| Example | 3037 | 1829 | 11 | 14 | 91 | 91.7 | 140 | No lithium |
| 3-7 | | | | | | | | precipitation |
| Example | 3089 | 1824 | 10 | 13 | 91.1 | 91.8 | 147 | No lithium |
| 3-8 | | | | | | | | precipitation |
| Example | 2187 | 1319 | 10 | 14 | 90.6 | 91.2 | 130 | No lithium |
| 3-9 | | | | | | | | precipitation |
| Example | 2669 | 1622 | 9 | 13 | 91.2 | 91.6 | 133 | No lithium |
| 3-10 | | | | | | | | precipitation |
| Example | 3878 | 2316 | 8 | 11 | 91.9 | 92.4 | 153 | Slight |
| 3-11 | | | | | | | | lithium |
| | | | | | | | | precipitation |

From Examples 3-1 to 3-11, it can be seen that when the types and percentages of the added isocyanate compound are within the ranges provided in this application, the obtained lithium-ion batteries exhibit a larger number of cycles at 45° C. and 60° C., lower thickness expansion rate at 100% SOC after high-temperature storage, lower thickness expansion rate at 0% SOC after high-temperature storage, and higher remaining capacity retention rate and recovered capacity retention rate at 100% SOC after high-temperature storage, thereby demonstrating that the lithium-ion batteries prepared using the electrolyte provided in this application can further improve the cycling performance and storage performance.

TABLE 7

| | | | Acid anhydride compound type and percentage e (%) | | | | |
|---|---|---|---|---|---|---|---|
| | | | | | | Pyridine-3,4- | |
| | b | a | | Citraconic | Succinic | dicarboxylic | |
| | (%) | (%) | Maleic anhydride | anhydride | anhydride | anhydride | a/e |
| Example | 1.5 | 2 | / | / | / | / | / |
| 1-5 | | | | | | | |
| Example | 1.5 | 2 | 0.01 | / | / | / | 200.00 |
| 4-1 | | | | | | | |
| Example | 1.5 | 2 | 0.1 | / | / | / | 20.00 |
| 4-2 | | | | | | | |
| Example | 1.5 | 2 | 0.5 | / | / | / | 4.00 |
| 4-3 | | | | | | | |
| Example | 1.5 | 2 | 1 | / | / | / | 2.00 |
| 4-4 | | | | | | | |
| Example | 1.5 | 2 | 2 | / | / | / | 1.00 |
| 4-5 | | | | | | | |
| Example | 1.5 | 2 | / | 0.5 | / | / | 4.00 |
| 4-6 | | | | | | | |
| Example | 1.5 | 2 | / | / | 0.5 | / | 4.00 |
| 4-7 | | | | | | | |
| Example | 1.5 | 2 | / | / | / | 0.5 | 4.00 |
| 4-8 | | | | | | | |
| Example | 1.5 | 0.5 | 0.5 | / | / | / | 1.00 |
| 4-9 | | | | | | | |
| Example | 1.5 | 1 | 0.5 | / | / | / | 2.00 |
| 4-10 | | | | | | | |
| Example | 1.5 | 3 | 0.5 | / | / | / | 6.00 |
| 4-11 | | | | | | | |

Note:
“/” in Table 7 means that a related preparation parameter does not exist.

TABLE 8

| | | | Thickness | Thickness | Remaining | Recovered | | |
|---|---|---|---|---|---|---|---|---|
| | | | expansion | expansion | capacity | capacity | | |
| | | | rate at 100% | rate at 0% | retention rate | retention rate | | Degree of |
| | | | SOC after | SOC after | at 100% SOC | at 100% SOC | | lithium |
| | Cycles | Cycles | high- | high- | after high- | after high- | | precipitation |
| | at | at | temperature | temperature | temperature | temperature | DCR | in charge |
| | 45° C. | 60° C. | storage (%) | storage (%) | storage (%) | storage (%) | (mΩ) | performance |
| Example | 2111 | 1224 | 30 | 41 | 86.9 | 88.8 | 138 | No lithium |
| 1-5 | | | | | | | | precipitation |
| Example | 2269 | 1361 | 28 | 32 | 87.6 | 88.2 | 138 | No lithium |
| 4-1 | | | | | | | | precipitation |
| Example | 2473 | 1469 | 23 | 26 | 88.9 | 90.5 | 140 | No lithium |
| 4-2 | | | | | | | | precipitation |
| Example | 3316 | 1980 | 10 | 12 | 91.6 | 92.2 | 144 | No lithium |
| 4-3 | | | | | | | | precipitation |
| Example | 3813 | 2299 | 7 | 8 | 92.2 | 92.8 | 147 | No lithium |
| 4-4 | | | | | | | | precipitation |
| Example | 2282 | 1374 | 13 | 15 | 89.3 | 89.7 | 182 | Severe |
| 4-5 | | | | | | | | lithium |
| | | | | | | | | precipitation |
| Example | 3201 | 1929 | 12 | 14 | 91.2 | 91.8 | 141 | No lithium |
| 4-6 | | | | | | | | precipitation |
| Example | 2976 | 1791 | 15 | 16 | 91 | 91.4 | 139 | No lithium |
| 4-7 | | | | | | | | precipitation |
| Example | 3592 | 2184 | 8 | 10 | 92 | 92.4 | 150 | No lithium |
| 4-8 | | | | | | | | precipitation |
| Example | 2123 | 1298 | 15 | 17 | 88.6 | 89.2 | 131 | No lithium |
| 4-9 | | | | | | | | precipitation |
| Example | 2575 | 1593 | 11 | 12 | 91 | 91.5 | 134 | No lithium |
| 4-10 | | | | | | | | precipitation |
| Example | 3967 | 2379 | 9 | 10 | 92.2 | 92.6 | 148 | Slight |
| 4-11 | | | | | | | | lithium |
| | | | | | | | | precipitation |

From Examples 4-1 to 4-11, it can be seen that when the types and percentages of the added acid anhydride compound are within the ranges provided in this application, the obtained lithium-ion batteries exhibit a larger number of cycles at 45° C. and 60° C., lower thickness expansion rate at 100% SOC after high-temperature storage, lower thickness expansion rate at 0% SOC after high-temperature storage, higher remaining capacity retention rate and recovered capacity retention rate at 100% SOC after high-temperature storage, thereby demonstrating that the lithium-ion batteries prepared using the electrolyte provided in this application can further improve the cycling performance and storage performance.

TABLE 9

| | | | Silane compound type and percentage f (%) | | | |
|---|---|---|---|---|---|---|
| | | | | | 1,3,5,7-tetravinyl- | |
| | | | | | 1,3,5,7- | |
| | b | a | Tetramethyldivinyldisil | Bis(trimethylsilyl) | tetramethylcyclotetra | |
| | (%) | (%) | oxane | maleate | siloxane | a/f |
| Example | 1.5 | 2 | / | / | / | / |
| 1-5 | | | | | | |
| Example | 1.5 | 2 | 0.1 | / | / | 20.00 |
| 5-1 | | | | | | |
| Example | 1.5 | 2 | 0.5 | / | / | 4.00 |
| 5-2 | | | | | | |
| Example | 1.5 | 2 | 1 | / | / | 2.00 |
| 5-3 | | | | | | |
| Example | 1.5 | 2 | 2 | / | / | 1.00 |
| 5-4 | | | | | | |
| Example | 1.5 | 2 | / | 0.5 | / | 4.00 |
| 5-5 | | | | | | |
| Example | 1.5 | 2 | / | / | 0.5 | 4.00 |
| 5-6 | | | | | | |
| Example | 1.5 | 0.5 | 0.5 | / | / | 1.00 |
| 5-7 | | | | | | |
| Example | 1.5 | 1 | 0.5 | / | / | 2.00 |
| 5-8 | | | | | | |
| Example | 1.5 | 3 | 0.5 | / | / | 6.00 |
| 5-9 | | | | | | |

Note:
“/” in Table 9 means that a related preparation parameter does not exist.

TABLE 10

| | | | Thickness | Thickness | Remaining | Recovered | | |
|---|---|---|---|---|---|---|---|---|
| | | | expansion | expansion | capacity | capacity | | |
| | | | rate at 100% | rate at 0% | retention rate | retention rate | | Degree of |
| | | | SOC after | SOC after | at 100% SOC | at 100% SOC | | lithium |
| | Cycles | Cycles | high- | high- | after high- | after high- | | precipitation |
| | at | at | temperature | temperature | temperature | temperature | DCR | in charge |
| | 45° C. | 60° C. | storage (%) | storage (%) | storage (%) | storage (%) | (mΩ) | performance |
| Example | 2111 | 1224 | 30 | 41 | 86.9 | 88.8 | 138 | No lithium |
| 1-5 | | | | | | | | precipitation |
| Example | 2389 | 1432 | 25 | 29 | 88.3 | 89.5 | 137 | No lithium |
| 5-1 | | | | | | | | precipitation |
| Example | 3269 | 1975 | 20 | 22 | 90.9 | 91.2 | 139 | No lithium |
| 5-2 | | | | | | | | precipitation |
| Example | 3739 | 2259 | 15 | 17 | 91.2 | 91.7 | 143 | No lithium |
| 5-3 | | | | | | | | precipitation |
| Example | 2264 | 1326 | 15 | 14 | 88.9 | 89.4 | 181 | Severe |
| 5-4 | | | | | | | | lithium |
| | | | | | | | | precipitation |
| Example | 3003 | 1806 | 22 | 26 | 91 | 91.2 | 130 | No lithium |
| 5-5 | | | | | | | | precipitation |
| Example | 3475 | 2079 | 12 | 13 | 91.5 | 91.8 | 141 | No lithium |
| 5-6 | | | | | | | | precipitation |
| Example | 2121 | 1232 | 26 | 28 | 88.2 | 88.8 | 120 | No lithium |
| 5-7 | | | | | | | | precipitation |
| Example | 2386 | 1418 | 23 | 25 | 90 | 90.5 | 128 | No lithium |
| 5-8 | | | | | | | | precipitation |
| Example | 3643 | 2188 | 17 | 18 | 91.5 | 92 | 137 | No lithium |
| 5-9 | | | | | | | | precipitation |

From Examples 5-1 to 5-9, it can be seen that when the types and percentages of the added silane compound are within the ranges provided in this application, the obtained lithium-ion batteries exhibit a larger number of cycles at 45° C. and 60° C., lower thickness expansion rate at 100% SOC after high-temperature storage, lower thickness expansion rate at 0% SOC after high-temperature storage, higher remaining capacity retention rate and recovered capacity retention rate at 100% SOC after high-temperature storage, and a lower degree of lithium precipitation, thereby demonstrating that the lithium-ion batteries prepared using the electrolyte provided in this application possess excellent kinetic performance while exhibiting good cycling performance and storage performance.

TABLE 11

| | | | Nitrogen-containing heterocyclic boron trifluoride complex type | | | | |
|---|---|---|---|---|---|---|---|
| | | | and percentage g (%) | | | | |
| | | | Boron | Boron | Boron | 2-fluoropyridine | |
| | | | trifluoride | trifluoride | trifluoride | boron trifluoride | |
| | b (%) | a (%) | pyridine | pyrazine | pyridazine | complex | a/g |
| Example | 1.5 | 2 | / | / | / | / | / |
| 1-5 | | | | | | | |
| Example | 1.5 | 2 | 0.01 | / | / | / | 200.00 |
| 6-1 | | | | | | | |
| Example | 1.5 | 2 | 0.1 | / | / | / | 20.00 |
| 6-2 | | | | | | | |
| Example | 1.5 | 2 | 0.5 | / | / | / | 4.00 |
| 6-3 | | | | | | | |
| Example | 1.5 | 2 | 1 | / | / | / | 2.00 |
| 6-4 | | | | | | | |
| Example | 1.5 | 2 | / | 0.5 | / | / | 4.00 |
| 6-5 | | | | | | | |
| Example | 1.5 | 2 | / | / | 0.5 | / | 4.00 |
| 6-6 | | | | | | | |
| Example | 1.5 | 2 | / | / | / | 0.5 | 4.00 |
| 6-7 | | | | | | | |
| Example | 1.5 | 0.5 | 0.5 | / | / | / | 1.00 |
| 6-8 | | | | | | | |
| Example | 1.5 | 1 | 0.5 | / | / | / | 2.00 |
| 6-9 | | | | | | | |
| Example | 1.5 | 3 | 0.5 | / | / | / | 6.00 |
| 6-10 | | | | | | | |

Note:
“/” in Table 11 means that a related preparation parameter does not exist.

TABLE 12

| | | | | | Remaining | Recovered | | |
|---|---|---|---|---|---|---|---|---|
| | | | Thickness | Thickness | capacity | capacity | | |
| | | | expansion | expansion | retention | retention | | |
| | | | rate at | rate at 0% | rate at 100% | rate at 100% | | Degree of |
| | | | 100% SOC | SOC after | SOC after | SOC after | | lithium |
| | Cycles | Cycles | after high- | high- | high- | high- | | precipitation |
| | at | at | temperature | temperature | temperature | temperature | DCR | in charge |
| | 45° C. | 60° C. | storage (%) | storage (%) | storage (%) | storage (%) | (mΩ) | performance |
| Example | 2111 | 1224 | 30 | 41 | 86.9 | 88.8 | 138 | No lithium |
| 1-5 | | | | | | | | precipitation |
| Example | 2368 | 1420 | 22 | 25 | 88 | 88.9 | 138 | No lithium |
| 6-1 | | | | | | | | precipitation |
| Example | 2759 | 1698 | 15 | 17 | 89.6 | 90.8 | 140 | No lithium |
| 6-2 | | | | | | | | precipitation |
| Example | 3594 | 2183 | 8 | 8 | 92.2 | 92.7 | 142 | No lithium |
| 6-3 | | | | | | | | precipitation |
| Example | 4123 | 2498 | 5 | 4 | 92.8 | 93.4 | 150 | No lithium |
| 6-4 | | | | | | | | precipitation |
| Example | 3663 | 2215 | 4 | 4 | 92.3 | 92.8 | 144 | No lithium |
| 6-5 | | | | | | | | precipitation |
| Example | 3683 | 2263 | 4 | 4 | 92.5 | 92.9 | 145 | No lithium |
| 6-6 | | | | | | | | precipitation |
| Example | 3571 | 2153 | 8 | 9 | 92 | 92.5 | 140 | No lithium |
| 6-7 | | | | | | | | precipitation |
| Example | 2426 | 1475 | 8 | 8 | 91.6 | 92 | 130 | No lithium |
| 6-8 | | | | | | | | precipitation |
| Example | 3063 | 1878 | 6 | 7 | 92 | 92.4 | 137 | No lithium |
| 6-9 | | | | | | | | precipitation |
| Example | 4210 | 2583 | 6 | 6 | 92.8 | 93.4 | 150 | Slight |
| 6-10 | | | | | | | | lithium |
| | | | | | | | | precipitation |

From Examples 6-1 to 6-10, it can be seen that when the types and percentages of the added nitrogen-containing heterocyclic boron trifluoride complex are within the ranges provided in this application, the obtained lithium-ion batteries exhibit a larger number of cycles at 45° C. and 60° C., lower thickness expansion rate at 100% SOC after high-temperature storage, lower thickness expansion rate at 0% SOC after high-temperature storage, and higher remaining capacity retention rate and recovered capacity retention rate at 100% SOC after high-temperature storage, thereby demonstrating that the lithium-ion batteries prepared using the electrolyte provided in this application can further improve the cycling performance and storage performance.

The above descriptions are only preferred embodiments of this application and are not intended to limit this application. Any modifications, equivalent replacements, improvements, and the like made within the spirit and principles of this application shall be included within the protection scope of this application.

What is claimed is:

1. A secondary battery, comprising a positive electrode plate, a negative electrode plate, and an electrolyte; wherein the electrolyte comprises vinylene carbonate; and based on a total mass of the electrolyte, a mass percentage a of the vinylene carbonate is 0.1% to 3%; and
the positive electrode plate comprises a positive electrode active material, the positive electrode active material comprises carbon element; and based on a total mass of the positive electrode active material, a mass percentage b of the carbon element is 0.5% to 6%.

2. The secondary battery according to claim 1, wherein a is 0.1% to 2.5%, and/or b is 0.5% to 5%.

3. The secondary battery according to claim 1, wherein a is 0.5% to 2.5%, and/or b is 0.5% to 4.5%.

4. The secondary battery according to claim 1, wherein a is 0.8% to 2.5%, and/or b is 0.5% to 4.5%.

5. The secondary battery according to claim 1, wherein a ratio of a to b is in a range of 0.22 to 6.

6. The secondary battery according to claim 1, wherein the electrolyte further comprises a nitrogen-containing heterocyclic compound; and based on the total mass of the electrolyte, a mass percentage c of the nitrogen-containing heterocyclic compound is 0.01% to 1%;
the nitrogen-containing heterocyclic compound comprises at least one of the following compounds represented by formula (I) or formula (II): 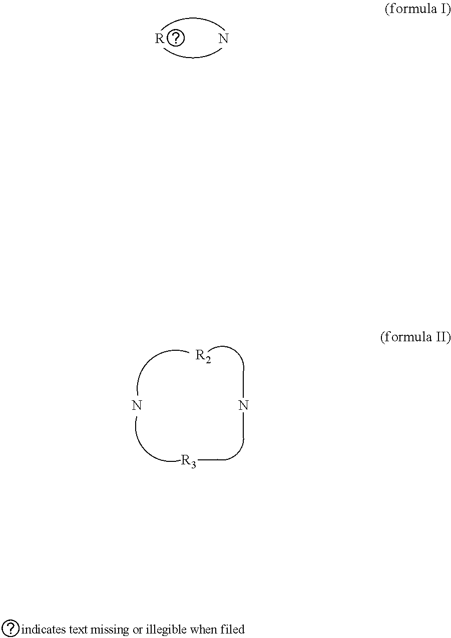
wherein R₁, R₂, and R₃ are each independently selected from any one of a substituted or unsubstituted C₁-C₅alkylene group, a substituted or unsubstituted C₂-C₅ alkenylene group, a substituted or unsubstituted C₂-C₅ alkynylene group, or a substituted or unsubstituted C₃-C₅ dienylene group, and during substitution, a substituent is a halogen atom.

7. The secondary battery according to claim 6, wherein a ratio of a to c is in a range of 2 to 60.

8. The secondary battery according to claim 1, wherein the electrolyte further comprises an isocyanate compound; and based on the total mass of the electrolyte, a mass percentage d of the isocyanate compound is 0.01% to 2%;
the isocyanate compound comprises at least one of the following compounds represented by formula (III) or formula (IV): 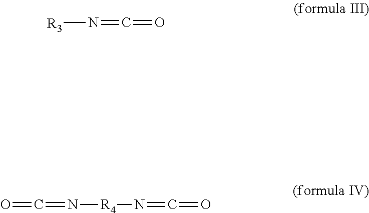
wherein the isocyanate compound comprises at least one-NCO group, and R₃ and R₄ are each independently selected from a C₁-C₇ hydrocarbon group or a C₁-C₇ aromatic hydrocarbon group.

9. The secondary battery according to claim 8, wherein a ratio of a to d is in a range of 2 to 60.

10. The secondary battery according to claim 1, wherein the electrolyte further comprises an acid anhydride compound; and based on the total mass of the electrolyte, a mass percentage e of the acid anhydride compound is 0.01% to 2%.

11. The secondary battery according to claim 10, wherein a ratio of a to e is in a range of 2 to 60.

12. The secondary battery according to claim 10, wherein the acid anhydride compound comprises at least one of maleic anhydride, dimethylmaleic anhydride, citraconic anhydride, glutaric anhydride, succinic anhydride, itaconic anhydride, biphenyl anhydride, pyridine dicarboxylic anhydride, pyrazine dicarboxylic anhydride, 2,3-pyridine dicarboxylic anhydride, pyridine-3,4-dicarboxylic anhydride, or 2,3-pyrazine dicarboxylic anhydride.

13. The secondary battery according to claim 1, wherein the electrolyte further comprises a silane compound; and based on the total mass of the electrolyte, a mass percentage f of the silane compound is 0.01% to 2%.

14. The secondary battery according to claim 13, wherein a ratio of a to f is in a range of 2 to 60.

15. The secondary battery according to claim 13, wherein the silane compound comprises at least one of tetramethyldivinyldisiloxane, bis(trimethylsilyl) maleate, diphenyldifluorosilane, heptamethyldisilazane, tetramethyldivinyldisiloxane, tetraethoxysilane, 2-cyanoethyltriethoxysilane, 1,3,5,7-tetravinyl-1,3,5,7-tetramethylcyclotetrasiloxane, 2,4,6-trivinyl-2,4,6-trimethylcyclotrisiloxane, or vinyltriethoxysilane.

16. The secondary battery according to claim 1, wherein the electrolyte further comprises a nitrogen-containing heterocyclic boron trifluoride complex; and based on the total mass of the electrolyte, a mass percentage g of the nitrogen-containing heterocyclic boron trifluoride complex is 0.01% to 1%.

17. The secondary battery according to claim 16, wherein a ratio of a to g is in a range of 2 to 60.

18. The secondary battery according to claim 16, wherein the nitrogen-containing heterocyclic boron trifluoride complex comprises at least one of boron trifluoride pyridine, boron trifluoride pyrazine, boron trifluoride pyridazine, 2-fluoropyridine boron trifluoride complex, boron trifluoride pyrimidine, boron trifluoride pyrrole, boron trifluoride pyrazole, or boron trifluoride imidazole.

19. The secondary battery according to claim 1, wherein the positive electrode active material comprises at least one of lithium iron phosphate or lithium manganese iron phosphate.

20. An electronic device, comprising a secondary battery, the secondary battery comprises a positive electrode plate, a negative electrode plate, and an electrolyte; wherein the electrolyte comprises vinylene carbonate; and based on a total mass of the electrolyte, a mass percentage a of the vinylene carbonate is 0.1% to 3%; and
the positive electrode plate comprises a positive electrode active material, the positive electrode active material comprises carbon element; and based on a total mass of the positive electrode active material, a mass percentage b of the carbon element is 0.5% to 6%.
